(19) United States
(12) Patent Application Publication
(10) Pub. No.: US 2010/0245310 A1
(43) Pub. Date: Sep. 30, 2010

(54) LUMINANCE CONTROL METHOD AND DISPLAY

(76) Inventor: Masahiro Hashimoto, Tokyo (JP)

Correspondence Address: Mr. Jackson Chen, 6535 N. STATE HWY 161, IRVING, TX, 75039, US

(21) Appl. No.: 12/739,780

(22) PCT Filed: Oct. 24, 2008
(86) PCT No.: PCT/JP2008/069343

§ 371 Date: Apr. 26, 2010

(30) Foreign Application Priority Data
Nov. 1, 2007 (JP) 2007-284637

(51) Int. Cl. G09G 5/10

(52) U.S. Cl. 345/207

(57) ABSTRACT

A display device includes a display panel, a light emitting device that provides backlight to the display panel, and a control device that determines the brightness of the backlight that the light emitting device should provide. The control device detects a timing when the brightness of the backlight illuminating the display panel is switched; recognizes an updated brightness level that should replace, as the one to be applied, an initial brightness level representing the brightness of the backlight at the detection timing; and changes the brightness of the backlight step by step after the detection timing from the initial brightness level to the updated brightness level.

### TECHNICAL FIELD

The present invention relates to a technique of controlling the brightness (luminance) of a backlight of a display device.

### BACKGROUND ART

Regarding a portable terminal such as cellular phone, for example, when the case of a folding type is flipped open or when a user operates a terminal, a backlight of LCD (Liquid Crystal Display) is automatically switched on and the screen becomes bright. Moreover, as a measure for reducing power consumption in terminals, there is a well-known function of automatically turning off the backlight after a predetermined period of time has passed without any operation.

A predetermined level of brightness is set in the backlight of the terminal screen for each of operating scenes of the terminal such as executed applications and occurrence of events. Therefore, the screen switches to a different level of brightness depending on operating scene. For example, the reason the screen becomes bright when the case is opened is that the switched-off backlight is designed to be switched on in the event of the case opening.

On the other hand, even if the screen becomes bright after the backlight is switched on, it may be difficult to see the screen in extremely bright conditions such as areas around lighting equipment or under clear skies. By contrast, in low light conditions such as at night, the screen may be felt to be too bright. For example, disclosed in the PTL 1 described below is a technique to address such disadvantages of backlight. A method disclosed in the document is to detect the brightness level of the surrounding area using a light sensor and adjust the brightness of a backlight according to the detection result.

### CITATION LIST

### Patent Literature

{PTL 1} JP-A-2003-258975

### SUMMARY OF INVENTION

### Technical Problem

According to the method disclosed in the above PTL 1, the brightness of the backlight is adjusted according to the brightness level of the surrounding area. However, for example, at the time of occurrence of an event, the brightness of the screen changes to a predetermined level of brightness in a moment. Accordingly, particularly when the brightness changes to a different level in response to an event that a user does not expect to happen, such as lighting caused by the receiving of a call or a reduction in brightness for power saving, it may become more difficult for a user to use the terminal conveniently because the brightness of the screen abruptly changes.

Moreover, in these days, there is a tendency to add various kinds of application to the terminal. Therefore, the terminal is required to have enough power to express various visual effects.

An object of the present invention is to provide a technique of achieving convenience for users as well as improving the power of expression on the screen in controlling the brightness of the backlight.

### SOLUTION TO PROBLEM

According to the present invention, a brightness control method includes the steps of: detecting a timing when the brightness of a backlight illuminating a display panel is switched; recognizing an updated brightness level that is used in place of an initial brightness level representing the brightness of the backlight at the detection timing; and changing the brightness of the backlight step by step after the detection timing from the initial brightness level to the updated brightness level.

According to the present invention, a display device includes a display panel, a light emitting device that provides backlight to the display panel, and a control device that determines the brightness of the backlight that the light emitting device should provide. The control device detects a timing when the brightness of the backlight illuminating the display panel is switched; an updated brightness level that is used in place of an initial brightness level representing the brightness of the backlight at the detection timing; and changes the brightness of the backlight step by step after the detection timing from the initial brightness level to the updated brightness level.

### ADVANTAGEOUS EFFECTS OF INVENTION

According to the present invention, it is possible to achieve convenience for users as well as improving the power of expression on the screen in controlling the brightness of the backlight.

### BRIEF DESCRIPTION OF DRAWINGS

FIG. 1 is a diagram illustrating the configuration of a display device according to an embodiment of the present invention.

FIG. 2 is an explanatory diagram for brightness step-by-step control according to the embodiment of the present invention.

FIG. 3 is an explanatory diagram for brightness light adjustment control according to the embodiment of the present invention.

FIG. 4 is an explanatory diagram for operating scenes according to the embodiment of the present invention.

FIG. 5 is an explanatory diagram for mixed brightness control according to the embodiment of the present invention.

100: Display device
101: Control CPU
102: LCD driver
103: LED power source IC
104: LCD panel
105: Brightness sensor
106: Nonvolatile memory
11: Scene detection section
12: Brightness search section
13: Brightness adjustment section
14: Sensor interface
21: Classified-by-scene brightness list (list of brightness classified by scene)
22: Correction table

### DESCRIPTION OF EMBODIMENTS

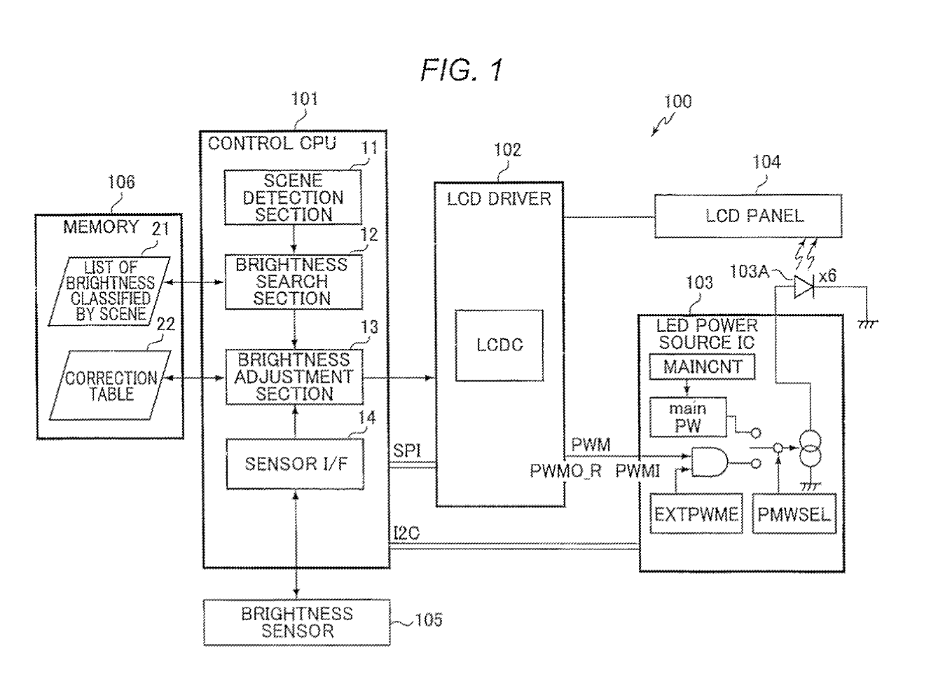

FIG. 1 shows the configuration of a display device according to an embodiment of the present invention. According to the present embodiment, a display device 100 is expected to be incorporated into a portable terminal (not shown in the diagram) such as a cellular phone. As shown in FIG. 1, the display device 100 includes a control CPU 101, a LCD driver 102, a LED 103A, a LED power source IC 103, a LCD panel 104, a brightness sensor 105, and a nonvolatile memory 106. {0014} The LED 103A and the LED power source IC 103 correspond to a light emitting device of the present invention. The control CPU 101 corresponds to a control device of the present invention. The control CPU 101 controls the brightness of a backlight as well as the operations of the terminal such as communication and data processing.

The control CPU 101 uses SPI (Serial Peripheral Interface) to transmit drawing data and various kinds of instruction to the LCD driver 102 and controls the LED power source IC 103 through another serial I/F I2C. The brightness sensor 105 measures the brightness level of the surrounding area and outputs a measured value. The measured value from the brightness sensor 105 is supplied to the control CPU 101 through a sensor interface 14.

The LCD driver 102 uses a PWM (Pulse Width Modulation) function of a LCD controller (LCDC) to output from a dedicated output terminal (PWMO_R) to the LED power source IC 103 a PWM signal that varies according to instructions from the control CPU 101. The PWM signal output from the LCD driver 102 is input to the LED power source IC 103 through a dedicated input terminal (PWMI). After undergoing the enable control (EXTPWME) and switch control (PWMSEL) of the PWM signal, the LED power source IC 103 provides backlight illumination from the LED 103A to the LCD panel 104. Thanks to the backlight illumination of the LED 103A, the LCD panel 104 makes an image of drawing data supplied from the LCD driver 102 visible.

A brightness list 21 and a correction table 22 are stored in advance in the nonvolatile memory 106. The brightness list 21 lists different levels of brightness being set for operating scenes, such as opening or closing the case of the terminal and receiving a call. The correction table 22 is used for a brightness light adjustment control process described below, and the like.

In the control CPU 101, a scene detection section 11 detects a current operating scene of the terminal as well as the switching of scenes. When the operating scene is switched, a brightness search section 12 recognizes, from the classified-by-scene brightness list (list of brightness classified by scene) 21, an updated brightness level as a backlight brightness level that should be newly applied. A brightness adjustment section 13 performs a brightness step-by-step control process to change the brightness of the backlight step by step. The brightness adjustment section 13 performs the brightness light adjustment control process to correct the current level of brightness in accordance with the brightness level of the surrounding area. The measured value of brightness supplied from the brightness sensor 105 and the correction table 22 are used for the correction.

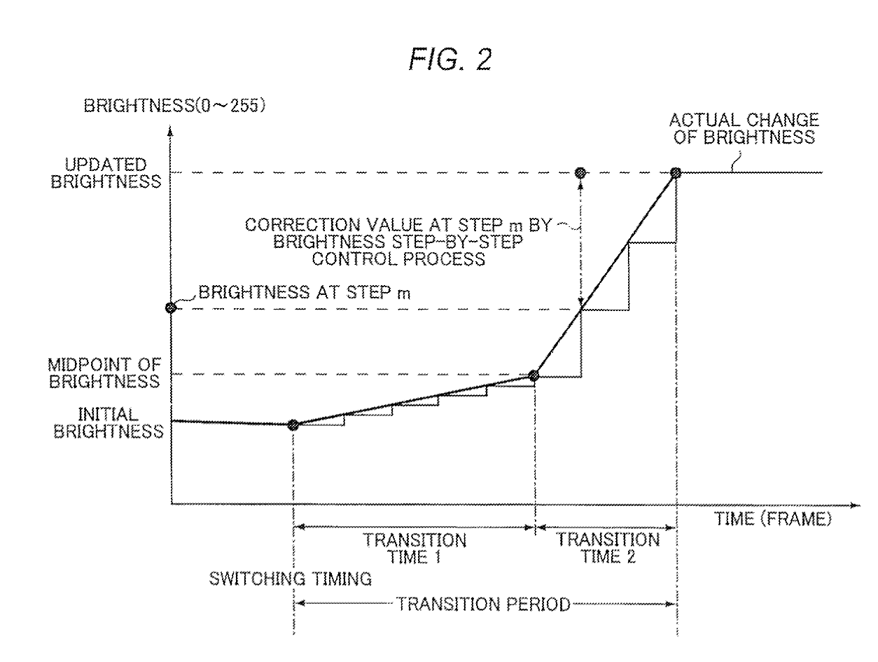

A brightness step-by-step control process of the brightness adjustment section 13 will be described with reference to FIG. 2. In the graph shown in the diagram, an initial brightness level represents the brightness level of the LED (103A) when the operating scene is switched. An updated brightness level represents a specified value selected from the classified-by-scene brightness list 21 (FIG. 1) for an operating scene after switching.

The brightness step-by-step control process is to cause the brightness of the backlight to change step by step by the predetermined number of graduations from the above initial brightness level to updated brightness level. When a new switching timing comes during the gradual change of brighmess, the brightness level at the time is reset as an initial brightness level and a new brightness step-by-step control process starts.

In the brightness step-by-step control process illustrated in FIG. 2, a brightness transition period is divided at the midpoint between the initial brightness level and the updated brightness level into two sections, “transition time 1” and “transition time 2.” The process is controlled so that the slope of the graph's line, or amount of change between steps, in one section is different from that of the other section. In the example illustrated in the diagram, the process is so controlled that the amount of change (or the slope of the line in the graph) in the “transition time 2” is larger than in the “transition time 1.” According to the above control process, the following visual effect is obtained: The brightness of the screen changes gradually in the first half of the process, and the speed of change increases in the latter half.

Incidentally, parameters, such as the number of divided sections of the transition period in the brightness step-by-step control process and the slope of the steps, are not limited to the above parameters. It is desirable that the parameters be changed in response to an arbitrary instruction from a user. In the example illustrated in FIG. 2, in response to the instruction from a user that the transition period is divided into two, the brightness adjustment section 13 sets so as shown in the diagram.

For example, a parameter may be designed to divide the transition period into three or more sections or to keep the slope of the line constant from the initial brightness level to the updated brightness level without any division. By contrast, as opposed to the example illustrated in FIG. 2, the process may be set so that the slope becomes less steep to make the change in brightness smaller in the sections closer to the updated brightness level. In this manner, the settings of the brightness step-by-step control process can be changed appropriately according to the visual effects required for each operating scene.

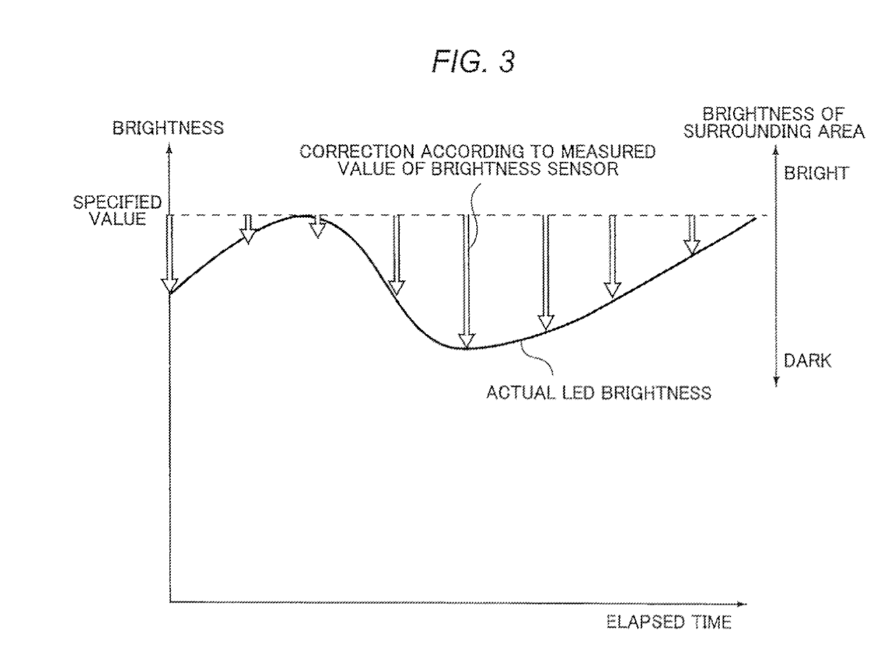

The brightness light adjustment control process of the brightness adjustment section 13 will be described with reference to FIG. 3. The brightness light adjustment control process is for correcting the brightness of the backlight in accordance with the brightness level of the surrounding area measured by the brightness sensor 105. As shown in FIG. 3, a specified value in an operating scene is regarded as the upper limit. Correction is made so as to increase the brightness under high illumination conditions and to decrease the brightness under low illumination conditions, thereby making the screen easy to see under any circumstances.

In the brightness light adjustment control process, a preset value t of an update time that is stored in advance in the nonvolatile memory 106 is used; the measured value (lux) is read from the brightness sensor 105 at time intervals of, for example, “t×10 milliseconds.” One measured value read may be used without change. However, in order to prevent the screen from flickering due to an abrupt change in the brightness level of the surrounding area, the following procedure is possible: The moving average value of, for example, 10 measured values that are sequentially read is calculated; and a correction value corresponding to the moving average value is obtained from the correction table 22 of the nonvolatile memory 106 and reflected in the brightness level of the backlight at the time.

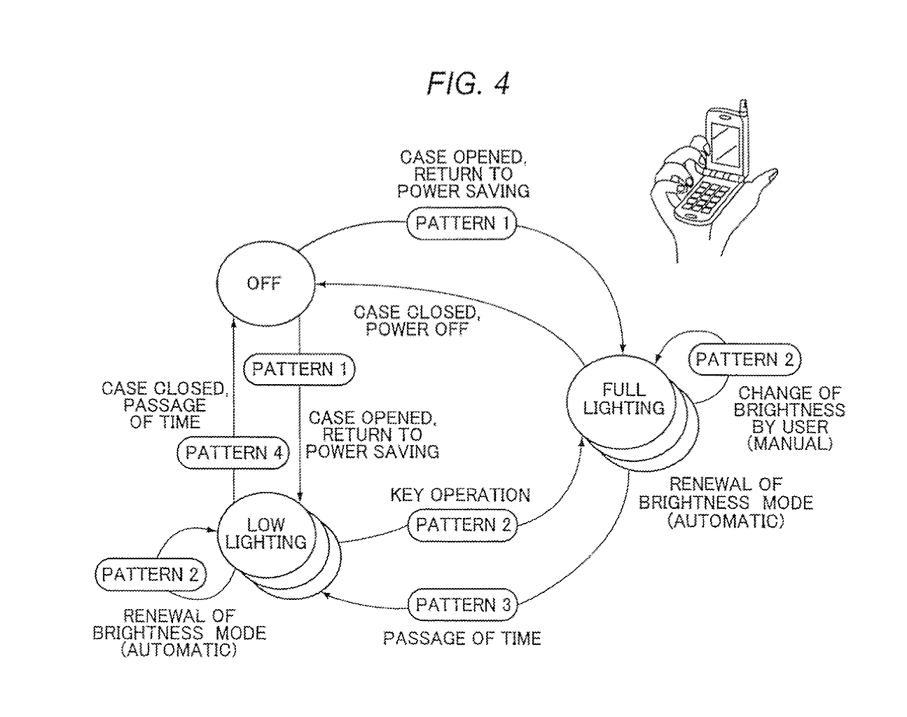

FIG. 4 shows an example of an operating scene to which the brightness control process of the present embodiment is applied. In this case, there are mainly three categories, “OFF,” “Low lighting,” and “Full lighting,” in terms of the brightness level of the backlight. In each of switching patterns like “pattern—” illustrated in the diagram, the above brightness step-by-step control process is performed. For example, the “pattern 4” is a case in which the backlight switches from “Low lighting” to “OFF” since the opened case is closed or since a predetermined period of time has passed without any operation.

As shown in FIG. 4, a “brightness mode renewing (updating)” function is provided for “Low lighting” to automatically switch in terms of brightness level after a predetermined period of time has passed in the operating scene. The function allows “Low lighting” to switch among a plurality of levels. Suppose that the amount of change between the levels is smaller than the amount of change from “Low lighting” to “Full lighting” (or “OFF”). {0028} In addition to an automatic “brightness mode renewing” function which is similar to the one described above, a “user brightness changing” function is for “Full lighting” to allow a user to arbitrarily adjust brightness. Suppose that the amount of change by the function is also smaller than the amount of change from “Full lighting” to “Low lighting” (or “OFF”).

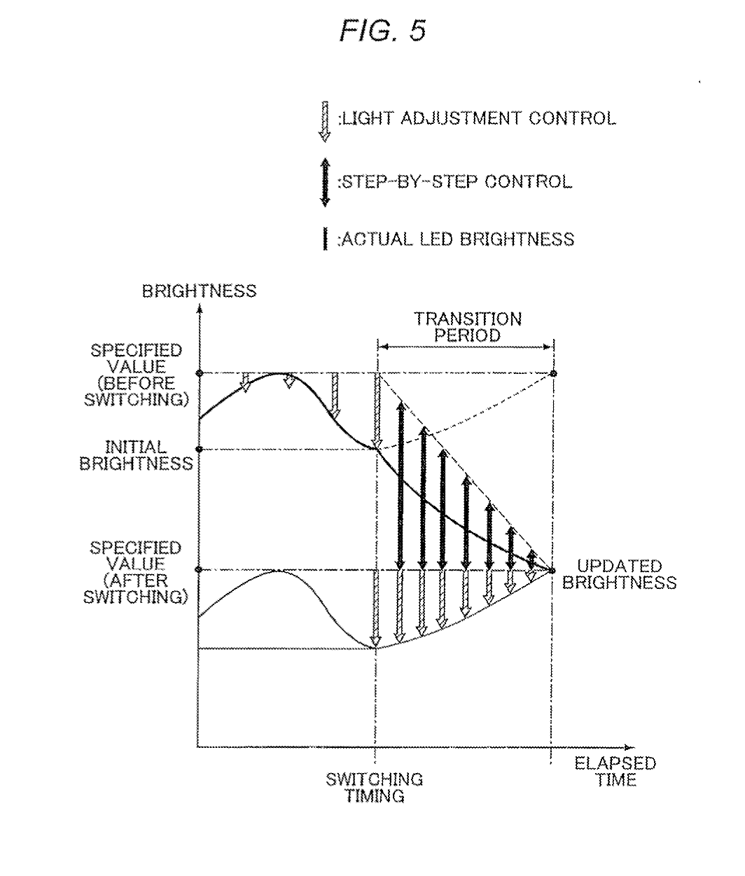

With reference to FIG. 5, a mixed process of brightness control of the backlight will be described. In the process, during the transition period of the brightness step-by-step control process triggered by the switching of operating scenes, the brightness light adjustment control process will take place in parallel in response to the brightness level of the surrounding area. In an example illustrated in the diagram, the brightness level is so controlled as to be lower when the operating scene is switched.

While performing the brightness light adjustment control process with the upper limit set at a specified value (before switching), the brightness adjustment section 13 starts the brightness step-by-step control process with the brightness level at the time set as an initial brightness level when the switching of operating scene is detected (“switching timing”). In the present example of the brightness step-by-step control process, a specified value (after switching) corresponding to the switched scene is recognized as an updated brightness level; the brightness level is so controlled as to fall step by step from the initial brightness level to the updated brightness level by a constant amount of change. Incidentally, the control process that provides a constant amount of change may be replaced by a control process that provides a different amount of brightness change for each section as described in the above example of FIG. 2.

The brightness adjustment section 13 performs the brightness light adjustment control process using a measured value of the brightness sensor 105 in parallel with the above brightness step-by-step control process. As a result, the mixed brightness control process is realized as indicated by a bold line as “Actual LED brightness” in FIG. 5, as the backlight brightness level falls step by step with the brightness level of the surrounding area being taken into account during the transition period.

According to the present embodiment, the brightness step-by-step control process prevents an abrupt change in the brightness of the screen before or after the switching timing of brightness of the backlight. Moreover, the brightness step-by-step control process and the brightness light adjustment control process are performed in parallel. Therefore, the brightness level is corrected based on the brightness level of the surrounding area. Thus, the visual expression power of the backlight improves, achieving further convenience for users.

The embodiment of the present invention is not limited to the one described above. Modifications may occur within the scope of the appended claims. For example, although the brightness light adjustment control process is performed in accordance with the brightness level of the surrounding area in addition to the brightness step-by-step control process in the above embodiment, only the brightness step-by-step control process may be performed without the brightness light adjustment control process in another embodiment of the present invention. In this case, the brightness level of the backlight is linearly controlled as shown in FIG. 2.

The present invention is preferably applied to a small PC, an in-vehicle navigation device and other terminals having the LCD as well as the cellular phone.

The present application claims priority from Japanese Patent Application No. 2007-284637 filed on Nov. 1, 2007, the entire contents of which being incorporated herein by reference.

1. A brightness control method comprising:
detecting a timing when the brightness of a backlight illuminating a display panel is switched;
recognizing an updated brightness level that is used in place of an initial brightness level, the initial brightness level representing the brightness of the backlight at the detection timing; and
changing the brightness of the backlight step by step after the detection timing from the initial brightness level to the updated brightness level.

2. The brightness control method according to claim 1, wherein
the brightness of an area surrounding the display panel is measured during the brightness change of the backlight step by step, and the brightness of the backlight is corrected based on the result of measurement.

3. The brightness control method according to claim 1, wherein
a period during the brightness change of the backlight step by step is divided into sections, and a different amount of brightness change is set for each section.

4. The brightness control method according to claim 3, wherein
when the period is divided, the period is divided at a midpoint between the initial brightness level and the updated brightness level into two sections, and the amount of the brightness change changes across the midpoint.

5. The brightness control method according to claim 3, wherein
when the different amount of brightness change is set for each of the sections, a larger amount of change is set for a section that is closer to the updated brightness level among the sections.

6. A display device comprising a display panel, a light emitting device that provides backlight to the display panel, and a control device that determines the brightness of the backlight that the light emitting device should provide,
wherein the control device detects a timing when the brightness of the backlight illuminating the display panel is switched; recognizes an updated brightness level that is used in place of an initial brightness level, the initial brightness level representing the brightness of the backlight at the detection timing; and changes the brightness of the backlight step by step after the detection timing from the initial brightness level to the updated brightness level.

7. The display device according to claim 6, further comprising
a sensor that measures the brightness of an area surrounding the display panel, wherein
the control device measures the brightness of the area surrounding the display panel during the brightness change of the backlight step by step, and corrects the brightness of the backlight based on the result of measurement.

8. The display device according to claim 6, wherein
the control device divides a period during the brightness change of the backlight step by step into sections, and sets a different amount of brightness change for each section.

9. The display device according to claim 8, wherein
when the period is divided, the control device divides the period at a midpoint between the initial brightness level and the updated brightness level into two sections, and the amount of the brightness change changes across the midpoint.

10. The display device according to claim 8, wherein
when the different amount of brightness change is set for each of the sections, the control device sets a larger amount of change for a section that is closer to the updated brightness level among the sections.

11. A portable terminal comprising the display device claim 6 and communication device.
